(19) United States
(12) Patent Application Publication
(10) Pub. No.: US 2005/0202248 A1
(43) Pub. Date: Sep. 15, 2005

(54) Morphable body moldings, rub strips, and bumpers

(76) Inventors: Alan L. Browne, Grosse Pointe, MI (US); Nancy L. Johnson, Northville, MI (US)

Correspondence Address: KATHRYN A. MARRA;General Motors Corporation, Legal Staff, Mail Code 482-C23-B21, P.O. Box 300, Detroit, MI, 48265-3000, US

(21) Appl. No.: 11/077,497

(22) Filed: Mar. 10, 2005

Related U.S. Application Data
(60) Provisional application No. 60/552,877, filed on Mar. 12, 2004.

(51) Int. Cl. B29C 43/02

(52) U.S. Cl. 428/411.1; 264/320

(57) ABSTRACT

Disclosed herein is a morphable molding comprising an active material in operative communication with a surface of the molding, wherein activation of the active material by an external stimulus is operative to change the shape of the molding. Disclosed herein too is a method of changing the shape of a molding comprising activating an active material that is in operative communication with the molding; changing the shape, dimensions and/or stiffness of the active material; and changing the shape, dimensions and/or stiffness of the molding.

### CROSS-REFERENCE TO RELATED APPLICATIONS

This application claims the benefit of U.S. Provisional Application Ser. No. 60/552,877 filed Mar. 12, 2004, the entire contents of which are hereby incorporated by reference.

### BACKGROUND

This disclosure relates to morphable body moldings, and more particularly, to morphable body moldings for vehicle doors formed of shape memory materials.

Automotive trim parts, particularly body side moldings of various sorts have both decorative and protective functions. Generally, there are at least three pieces horizontally aligned and attached on the side of a vehicle: a piece for the front fender; a piece for each door; and a piece for the rear fender.

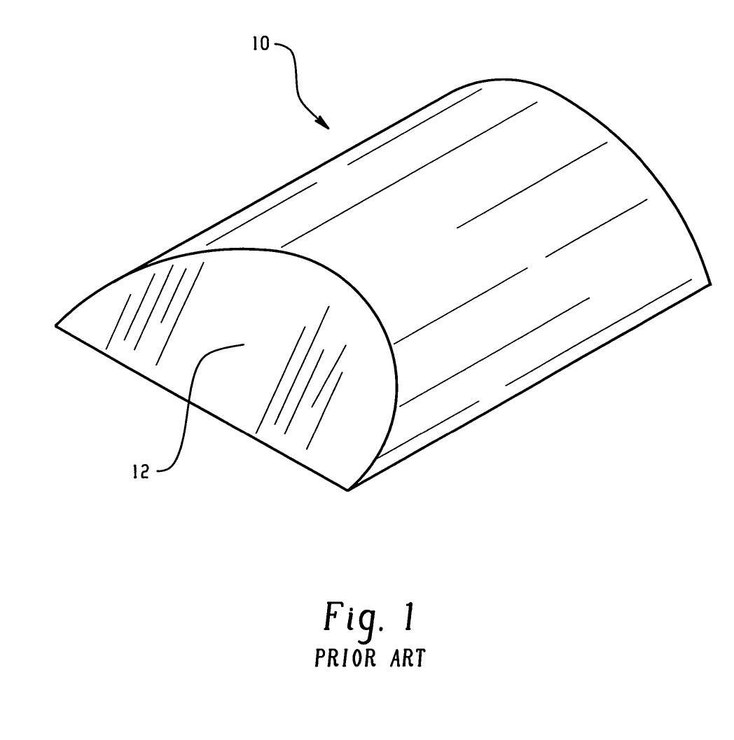

To permit opening and closure of door assemblies in automotive vehicles, a portion of the molding applied thereto must take into account the clearances associated with opening and closing. Accordingly, some vehicles require a portion of the molding to be cut-away or tapered to a thickness that permits opening and closure of the door without contact and/or damage to the moldings. The problem with having to form the molding in this manner is that it decreases the aesthetic qualities of the molding. From a distance, one has difficulty in distinguishing whether the cutaway portion represents damage to the vehicle. FIG. 1 illustrates an endview of a portion of a prior art molding 10 illustrating a tapered end 12, wherein the tapered end would be seated against the pivoting door portion of a vehicle door jam.

Accordingly, it is desired to have a molding that is morphable such that clearances can be maintained during door opening and closing, yet provide continuity of the molding so as to provide an aesthetic appearance.

### SUMMARY

Disclosed herein is a morphable molding comprising an active material in operative communication with a surface of the molding, wherein activation of the active material by an external stimulus is operative to change the shape of the molding.

Disclosed herein too is a morphable molding comprising an electrically conductive polymeric matrix; and a shape memory alloy dispersed in the electrically conductive polymeric matrix; wherein the shape memory alloy upon activation is operative to change the shape, stiffness or dimensions of the morphable molding.

Disclosed herein too is a morphable molding comprising an active material in operative communication with a portion of the molding, wherein activation of the active material by an external stimulus is operative to change the shape, dimensions or stiffness of the molding.

Disclosed herein too is a trim molding for a vehicle, comprising a molding fixedly attached to a vehicle door having an end contiguous to the vehicle door hinge, wherein the molding comprises a shape memory actuator positioned in an interior of the molding, wherein the shape memory actuator tapers the molding in response to an activation signal to a degree effective to provide clearance for door opening and closing.

Disclosed herein too is a method of changing the shape of a molding comprising activating an active material that is in operative communication with the molding; changing the shape, dimensions and/or stiffness of the active material; and changing the shape, dimensions and/or stiffness of the molding.

### DETAILED DESCRIPTION OF FIGURES

FIG. 1 illustrates an end view of a portion of a prior art molding 10 illustrating a tapered end 12, wherein the tapered end would be seated against the pivoting door portion of a vehicle door jam;

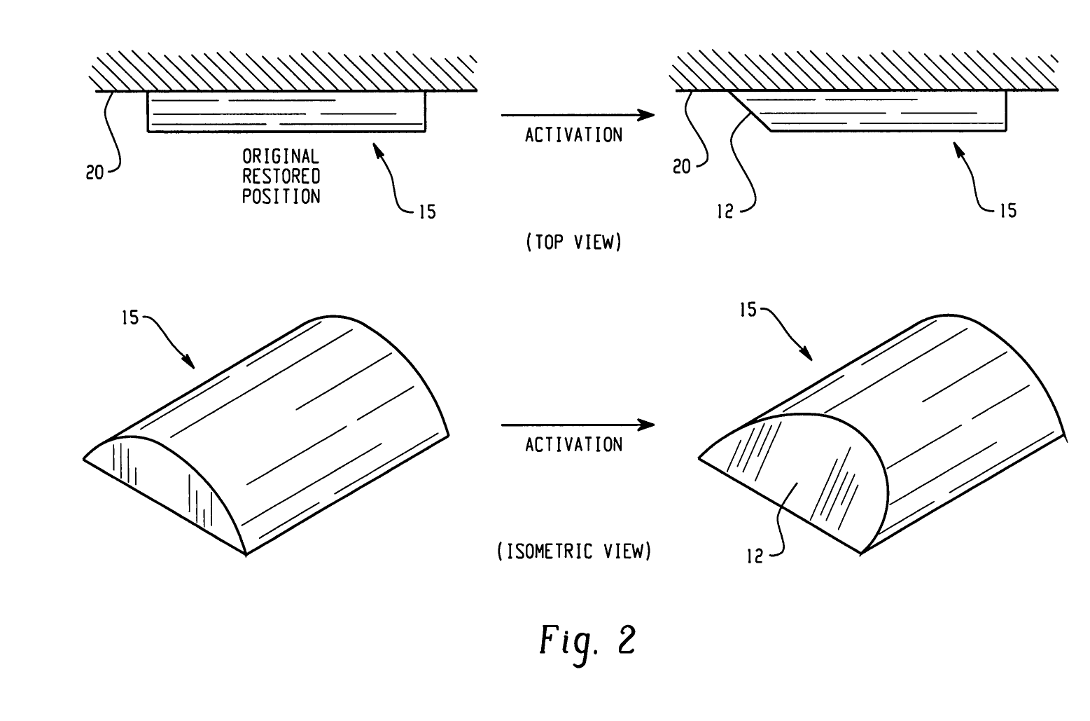

FIG. 2 illustrates an exemplary morphable molding 10 prior to and after the morphing takes place;

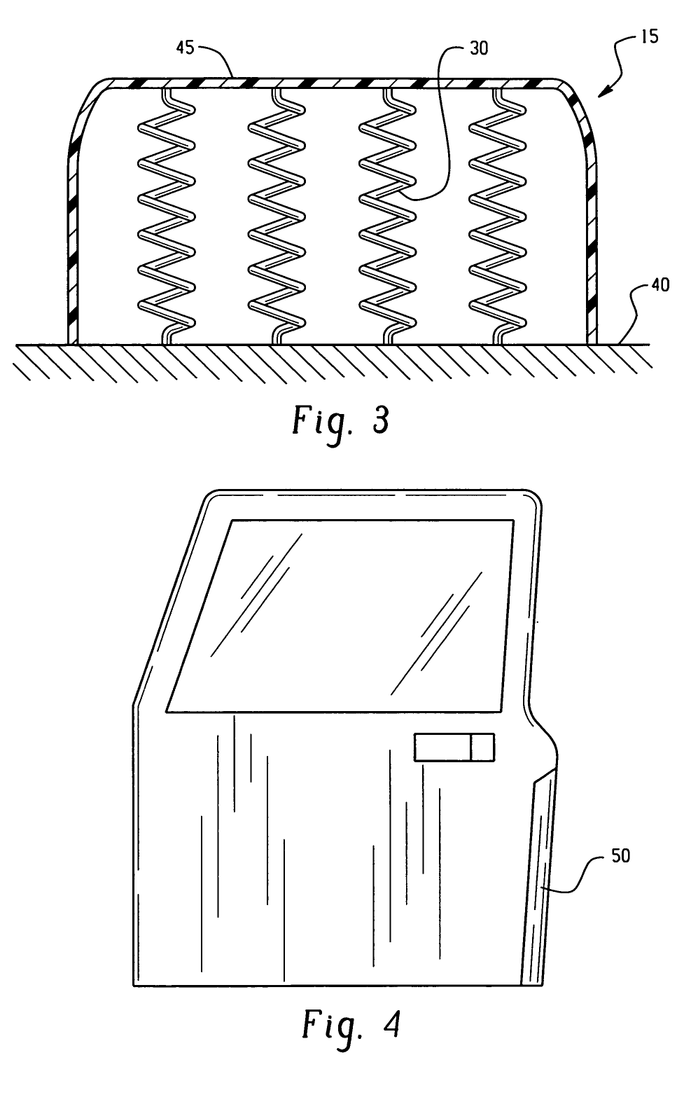

FIG. 3 illustrates a cross sectional view of another exemplary shape memory based actuation mechanism that can be employed in the morphable molding 10 of the FIG. 2. In the FIG. 3, springs 30 are formed of the shape memory alloy and positioned within the interior region of the molding. One end of the spring is fixedly attached to the base 40 of the molding whereas the other end is attached to the wall of the molding;

FIG. 4 is an exemplary depiction demonstrating one potential application of the morphable rub-strips 50 on the edge of an automobile door. The morphable rub-strips are preferably located on a portion of the door that is subject to “dings” upon door opening; and

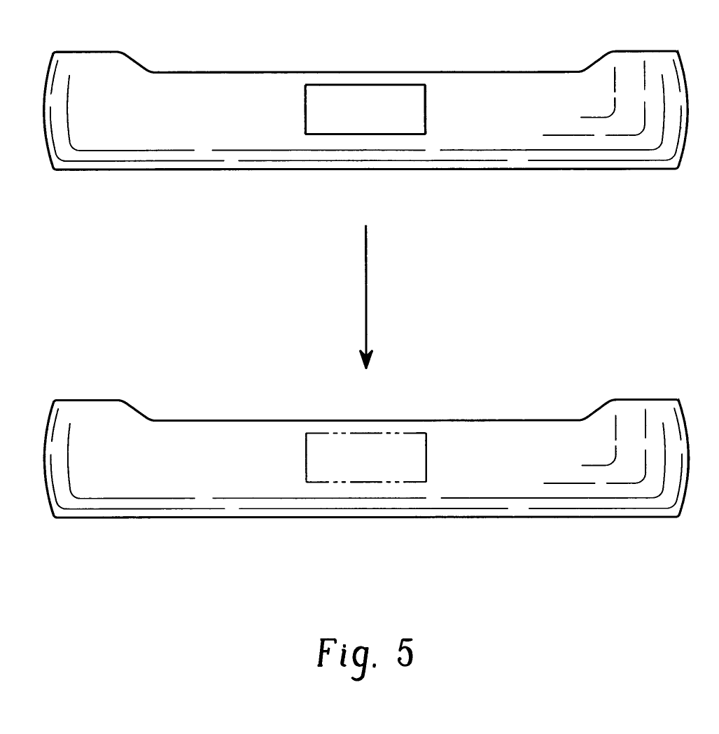

FIG. 5 is an exemplary depiction demonstrating a morphable bracket 62 on the front bumper 60 of an automobile. The bracket 62 can be formed when it is desired to attach a license plate to the front bumper 60 of the automobile. When it is desired to remove the license plate, the bumper 60 can be heat treated to remove the bracket 62.

### DETAILED DESCRIPTION

Disclosed herein are morphable body moldings formed from active materials (shape memory materials) for attachment to a vehicle interior or exterior. The morphable moldings can also advantageously be used in residential or buildings, an other articles such as machine tools, furniture, or the like. In one embodiment, the shape memory materials are preferably employed as actuators and disposed within the molding to effect morphing. In another embodiment, the shape memory materials are used to form the morphable surface of the morphable body molding. The morphable body molding can be used in a functional application or in a decorative application. The use of shape memory materials to form morphable body moldings permits the formation of erasable bas-relief exterior and interior displays in vehicles and buildings. It also permits the formation of healable and repairable exterior surfaces in vehicles, buildings, or the like that can withstand damage that occurs within the limits of plastic deformation of the material employed in the morphable body molding. As used herein the term vehicle is meant to encompass any body capable of locomotion, examples of which are automobiles, aircraft, boats and ships, or the like.

As noted above, the morphable body moldings comprise a shape memory material. By utilizing a shape memory material in the molding, the molding can reversibly change its modulus properties to provide a shape change to the molding. Applying an activation signal to the shape memory material can effect a reversible change. Suitable activation signals will depend on the type of shape memory material. As such, the activation signal provided for reversibly changing the shape and modulus properties of the molding structure may include a heat signal, an electrical signal, a magnetic signal, a mechanical signal, a chemical signal, or the like, or a combination comprising at least one of the foregoing signals, and the like.

The morphable molding generally comprises a polymer, a metal or a ceramic in contact with the active material. The active material may be disposed on the surface of the molding or disposed in the molding. Exemplary polymers are thermoplastic polymers, thermosetting polymers or blends of thermoplastic polymers with thermosetting polymers. In one embodiment, when the morphable molding comprises a polymer, the polymer can be a shape memory alloy. In another embodiment, when the morphable molding comprises a metal, the metal can be a shape memory alloy.

In one embodiment, the morphable molding comprises an active material in operative communication with a surface of the molding, wherein activation of the active material by an external stimulus is operative to change the shape, stiffness or dimensions of the molding. In another embodiment, the morphable molding comprises an active material in operative communication with a portion of the molding, wherein activation of the active material by an external stimulus is operative to change the shape, stiffness or dimensions of the molding. In yet another embodiment, the surface of the morphable molding comprises a shape memory material, which upon activation is operative to change the shape, stiffness or dimensions of the molding.

Exemplary shape memory materials include shape memory alloys (SMA), shape memory polymers (SMP), dielectric elastomers such as electroactive polymers (EAP), ferromagnetic SMAs, piezoelectric polymers, piezoelectric ceramics, various combinations of the foregoing materials, and the like. Of the above noted materials, SMAs, SMPs and EAPs are preferably utilized.

Shape memory alloys (SMA's) generally refer to a group of metallic materials that demonstrate the ability to return to some previously defined shape or size when subjected to an appropriate thermal stimulus. Shape memory alloys are capable of undergoing phase transitions in which their flexural modulus (stiffness), yield strength, and shape orientation are altered as a function of temperature. Generally, in the low temperature, or martensite phase, shape memory alloys can be plastically deformed and upon exposure to some higher temperature will transform to an austenite phase, or parent phase, returning to their shape prior to the deformation. Materials that exhibit this shape memory effect only upon heating are referred to as having one-way shape memory. Those materials that also exhibit shape memory upon re-cooling are referred to as having two-way shape memory behavior.

Shape memory alloys can exhibit a one-way shape memory effect, an intrinsic two-way effect, or an extrinsic two-way shape memory effect depending on the alloy composition and processing history. Annealed shape memory alloys generally only exhibit the one-way shape memory effect. Sufficient heating subsequent to low-temperature deformation of the shape memory material will induce the martensite to austenite type transition, and the material will recover the original, annealed shape. Hence, one-way shape memory effects are only observed upon heating.

Intrinsic and extrinsic two-way shape memory materials are characterized by a shape transition both upon heating from the martensite phase to the austenite phase, as well as an additional shape transition upon cooling from the austenite phase back to the martensite phase. Active elements that exhibit an intrinsic one-way shape memory effect are fabricated from a shape memory alloy composition that will cause the active elements to automatically reform themselves as a result of the above noted phase transformations. Intrinsic two-way shape memory behavior must be induced in the shape memory material through processing. Such procedures include extreme deformation of the material while in the martensite phase, heating-cooling under constraint or load, or surface modification such as laser annealing, polishing, or shot-peening. Once the material has been trained to exhibit the two-way shape memory effect, the shape change between the low and high temperature states is generally reversible and persists through a high number of thermal cycles. In contrast, active connector elements that exhibit the extrinsic two-way shape memory effects are composite or multi-component materials that combine a shape memory alloy composition that exhibits a one-way effect with another element that provides a restoring force to return the first plate another position or to its original position.

The temperature at which the shape memory alloy remembers its high temperature form when heated can be adjusted by slight changes in the composition of the alloy and through heat treatment. In nickel-titanium shape memory alloys, for instance, it can be changed from above about 100° C. to below about −100° C. The shape recovery process occurs over a range of several degrees and the start or finish of the transformation can be controlled to within a degree or two depending on the desired application and alloy composition.

Suitable shape memory alloy materials for fabricating the active elements include nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, or the like, or a combination comprising at least one of the foregoing shape memory alloys. The alloys can be binary, ternary, or any higher order so long as the alloy composition exhibits a shape memory effect, e.g., change in shape orientation, changes in yield strength, and/or flexural modulus properties, damping capacity, and the like.

In one embodiment, in one manner of employing an SMA in a morphable body molding, the reversible change in the modulus properties of the SMA can be used to provide a shape change to the molding. In this embodiment the morphable molding comprising the SMA is either used in an environment in which its temperature is above its transition temperature or it is heated above its transition temperature so that in either instance the SMA is in its austenite phase. When the SMA is in its austenitic phase, an appropriate amount of pressure can be applied to the morphable molding which causes a stress induced transformation to the considerably softer martensite phase. The subsequent deformation of the SMA is termed superelastic, it returning to its austenite phase and its preferred geometry therein upon removal of the applied pressure. In one embodiment, the application of pressure can be used to return the molding to its original configuration. In another embodiment, the pressure can be used to change the shape of the molding to a new configuration.

In an exemplary application, a part of a door can comprise a morphable molding that comprises a shape memory alloy. If the SMA element of the morphable molding gets damaged (when in its martensite phase), it can be heated above its transformation temperature to return it to its original shape so long as the damage is within the plastic deformation region and the damage does not result in the creation of a new surface (i.e., not torn, cut, or otherwise broken). When the SMA is in its austenitic form it can be deformed superelastically if desired upon door opening or pressure loading of any form. The door can therefore be closed and/or pressure removed which returns the SMA to its austenitic form and the morphable molding to its original shape.

Shape memory polymers (SMP's) may also be used in the morphable molding. SMP's generally refer to a group of polymeric materials that demonstrate the ability to return to some previously defined shape when subjected to an appropriate thermal stimulus while under very little to no external load. Shape memory polymers also display a huge drop in modulus by a factor of about 30 to about 100, depending on their composition, when subjected to a temperature above the glass transition temperature of their lower temperature segment. Shape memory polymers are capable of undergoing phase transitions in which their shape orientation is altered as a function of temperature. Generally, SMP's have two main segments, a hard segment and a soft segment. The previously defined or permanent shape can be set by melting or processing the polymer at a temperature higher than the highest thermal transition followed by cooling below that thermal transition temperature. The highest thermal transition is usually the glass transition temperature (Tg) or melting point of the hard segment. A temporary shape can be set by heating the material to a temperature higher than the Tg or the transition temperature of the soft segment, but lower than the Tg or melting point of the hard segment. The temporary shape is set while processing the material at the transition temperature of the soft segment followed by cooling to fix the shape. The material can be reverted back to the permanent shape by heating the material while under little to no load above the transition temperature of the soft segment.

Generally, SMPs are copolymers comprised of at least two different units which may be described as defining different segments within the co-polymer, each segment contributing differently to the flexural modulus properties and thermal transition temperatures of the material. The term “segment” refers to a block, graft, or sequence of the same or similar monomer or oligomer units that are copolymerized with a different segment to form a continuous crosslinked-interpenetrating network of these segments. These segments may be combinations of crystalline or amorphous materials and therefore may be generally classified as a hard segment(s) or a soft segment(s), wherein the hard segment generally has a higher glass transition temperature (Tg) or melting point than the soft segment. Each segment then contributes to the overall flexural modulus properties of the SMP and the thermal transitions thereof. When multiple segments are used, multiple thermal transition temperatures may be observed, wherein the thermal transition temperatures of the copolymer may be approximated as weighted averages of the thermal transition temperatures of its comprising segments. The previously defined or permanent shape of the SMP can be set by blow molding the polymer at a temperature higher than the highest thermal transition temperature for the shape memory polymer or its melting point, followed by cooling below that thermal transition temperature.

In practice, in one embodiment of the present invention the SMP's employed as the active element are alternated between one of at least two shape orientations such that at least one orientation will provide a dimension reduction relative to the other orientation(s) when an appropriate thermal signal is provided. To set a permanent shape, the shape memory polymer must be at about or above its melting point or highest transition temperature (also termed “last” transition temperature). The active element is generally shaped at this temperature by molding or shaped with an applied force followed by cooling to set the permanent shape.

The temperature to set the permanent shape is generally between about 40° C. to about 300° C. The Tg of the SMP can be chosen for a particular application by modifying the structure and composition of the polymer. Transition temperatures of suitable SMPs generally range in an amount of about −63° C. to above about 160° C. Engineering the composition and structure of the polymer itself can allow for the choice of a particular temperature for a desired application. A preferred temperature for shape recovery is greater than or equal to about −30° C., more preferably greater than or equal to about 20° C., and most preferably a temperature greater than or equal to about 70° C. Also, a preferred temperature for shape recovery is less than or equal to about 250° C., more preferably less than or equal to about 200° C., and most preferably less than or equal to about 180° C.

Suitable shape memory polymers can be thermoplastics, interpenetrating networks, semi-interpenetrating networks, or mixed networks. The polymers can be a single polymer or a blend of polymers. The polymers can be linear or branched thermoplastic elastomers with side chains or dendritic structural elements. Suitable polymer components to form a shape memory polymer include, but are not limited to, polyphosphazenes, poly(vinyl alcohols), polyamides, polyester amides, poly(amino acid)s, polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysiloxanes, polyurethanes, polyethers, polyether amides, polyether esters, and copolymers thereof. Examples of suitable polyacrylates include poly(methyl methacrylate), poly(ethyl methacrylate), poly(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate) and poly(octadecyl acrylate). Examples of other suitable polymers include polystyrene, polypropylene, polyvinyl phenol, polyvinylpyrrolidone, chlorinated polybutylene, poly(octadecyl vinyl ether), ethylene vinyl acetate, polyethylene, poly(ethylene oxide)-poly(ethylene terephthalate), polyethylene/nylon (graft copolymer), polycaprolactones-polyamide (block copolymer), poly(caprolactone) dimethacrylate-n-butyl acrylate, poly(norbornyl-polyhedral oligomeric silsequioxane), polyvinylchloride, urethane/butadiene copolymers, polyurethane block copolymers, styrene-butadiene-styrene block copolymers, or the like, or a combination comprising at least one of the foregoing polymers.

As with the shape memory alloys, when a shape memory polymer is used in the morphable molding, a variety of geometrical shapes, as listed above, may be utilized. Additionally a variety of activation signals may be used. The preferred activation signal is a thermal activation signal provided by heating, exemplary means being conductive, convective, radiative, and resistive or combinations thereof.

FIG. 2 illustrates an exemplary morphable molding 15 or trim piece prior to and after the morphing takes place. The illustrated morphable molding 15 is exemplary only and is not intended to be limited to any particular shape, size, or the like property. The morphable molding 15 generally comprises a hollow profile having a base and walls extending therefrom to form an interior region. The illustrated morphable molding 15 can be fastened to a body 20 surface by means of an adhesive, fasteners, and the like.

As can be seen from the FIG. 2, in the original restored position, the edge of the molding has about a 90-degree profile as opposed to the tapered profile shown in FIG. 2. However, when the door is opened, a controller can be used to deliver the appropriate activation signal to cause the shape memory alloy contained in the molding to morph it to a tapered profile. As such, during use, the molding is continuous with the other portions of the molding that are longitudinally positioned on the vehicle door 20, thereby providing an aesthetic appearance to the vehicle as opposed to having the tapered portion visible at all times. Although discussion has been made specifically to tapered profiles, it should be understood that other profiles are acceptable and contemplated herein provided adequate clearance is provided by the morphed profile.

As noted above, the morphable molding can comprise an active material in operative communication with a portion of the molding, wherein activation of the active material by an external stimulus is operative to change the shape of the molding. Alternatively, the morphable molding can comprise an active material in operative communication with a portion of the molding, wherein activation of the active material by an external stimulus is operative to change the stiffness of the molding. Still alternatively, the morphable molding can comprise an active material in operative communication with a portion of the molding, wherein pressure loading of the SMA in its austenite phase transforms it to its martensite phase in so doing dropping its stiffness and that of the molding.

In one exemplary embodiment related to such a morphable molding, the morphable molding can comprise filler particles comprising a shape memory alloy that are dispersed in an polymer matrix. The polymer matrix can be made electrically conductive by incorporating electrically conductive fillers such as carbon black, carbon nanotubes into the matrix. An exemplary polymer matrix comprises elastomers. Activation of the shape memory alloy by resistive heating can be used to change the surface texture or the dimensions of the morphable molding. Activation of the shape memory alloy can also be used to change the stiffness of the morphable molding so as to deform it to any desired shape.

FIG. 3 illustrates a cross sectional view another exemplary shape memory based actuation mechanism that can be employed in the morphable molding 15 of the FIG. 2. In the FIG. 3, springs 30 are formed of the shape memory alloy and positioned within the interior region of the molding. One end of the spring is fixedly attached to the base 40 of the molding whereas the other end is attached to the wall of the molding. A controller (not shown) is in electrical communication with the shape memory alloy, wherein the controller is programmed to selectively deliver an activation signal to the shape memory alloy. In this manner, the controller can be programmed to deliver the activation signal upon door opening and discontinuing the activation signal upon door closing. Upon receiving the activation signal, the shape memory alloy springs contract causing the walls to flex inward. Discontinuation of the signal returns the SMA springs to their lower modulus martensite phase allowing the biasing stiffness of the molding walls to return it their starting undeformed shape. The activation signal could be initiated by using for example an electronic key fob, pressing the power unlock button, or the like. Other configurations other than the use of coils are contemplated herein. For example, various wires of shape memory alloys can be utilized to cause the desired displacement as would be apparent to those skilled in the art in view of this disclosure. Moreover, the desired displacement can also be obtained with the use of other shape memory materials such as EAPs.

In another embodiment, the vehicle door opening edge comprises a shape memory material so as to protect against impacts with other objects upon door opening. The morphable moldings, i.e., morphable rub-strips (edge-strips), may comprise a shape memory material adapted to change a shape orientation to protect the edge. Suitable shape memory materials include shape memory polymers, shape memory alloys, dielectric elastomers such as electroactive polymers, ferromagnetic SMAs, piezoelectric polymers, piezoelectric ceramics, various combinations of the foregoing materials, and the like.

As shown in FIG. 4, the morphable rub-strips 50 can be applied to the edge of the door, preferably at location subject to “dings” upon door opening. The morphable rub strips provide active damping by expanding outward in response to receipt of an applied activation signal. Using dielectric elastomers as an example for the expanding rub strip, a sealed tube of the dielectric elastomer is fabricated with a defined internal pressure and applied to the desired locations at about the vehicle edge. As voltage is applied, the morphable rub-strip 50 expands in diameter in an amount effective to provide protection against damage such as dings, or the like. In a related embodiment, the rub strips could be made of an SMP that would be heated and thus softened upon door opening to minimize any impact damage if they were to strike a neighboring object such as the side of a vehicle. Upon door closing the SMP would return to its original undeformed geometry and upon discontinuation of the activation signal would then harden upon cooling.

In yet another embodiment, the shape memory materials can be used to provide a morphable molded bumper 60 such as may be desired for disappearing license plate brackets 62 for molded front bumpers. Not all states require a front license to be attached to the front bumper. Currently, manufacturers fabricate two different parts to accommodate the different needs for those vehicles that need front license brackets and those that do not. The front license state bracket can be formed of a shape memory material such that activation of a suitable activation signal can cause the license bracket to disappear. For example, the bracket portion or the entire front bumper can be formed of a shape memory polymer material as shown in FIG. 5.

In one embodiment, activating the shape memory polymer by thermally heating the portion corresponding to the bracket, applying a load to indent the SMP in the location and shape required for the license plate bracket 62, and then cooling the SMP while maintaining the pressure will create the license plate bracket 62. If subsequently a mounting bracket is no longer desired then reheating the bracket region such as, for example, with a blow dryer in the absence of load will remove the indentation. FIG. 5 also shows how the indentation due to the bracket portion can be removed upon heating.

In yet other embodiments, regions of SMP can be located on various exterior and interior surfaces of the vehicle and used in the above manner (using heated tools shaped in the pattern that is desired) to create personalized/distinctive bas-relief engravings and displays, which could always be subsequently erased simply by reheating the region. In one embodiment, a plastically damaged portion (not torn, cut, or otherwise broken) of an automobile manufactured from a SMP would allow healing/repair of surface regions made of SMP. If a region of an automobile comprising an SMP is damaged to an extent that involves substantially plastic deformation, then by heating the SMP to a temperature greater than the lower Tg, it can be easily repaired.

The morphable moldings can be advantageously used in a variety of articles such as, for example, vehicles, residential and office buildings, furniture, machine tools, sign boards and sign posts, or the like. They can be morphed using an activation signal from a computer or by using a manually generated signal. The morphed moldings can be advantageously used for greater than or equal to about 1000 cycles, greater than or equal to about 10,000 cycles, greater than or equal to about 100,000 cycles, or the like.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A morphable molding comprising:
an active material in operative communication with a surface of the molding, wherein activation of the active material by an external stimulus is operative to change the shape of the molding.

2. The morphable molding of claim 1, wherein the active material is a shape memory material that can reversibly change shape, stiffness or size when subjected to the external stimulus.

3. The morphable molding of claim 2, wherein the external signal is a heat signal, an electrical signal, a magnetic signal, a mechanical signal, a chemical signal, or a combination comprising at least one of the foregoing signals.

4. The morphable molding of claim 2, wherein the shape memory material is a shape memory alloy, a shape memory polymer, a dielectric elastomer, an electroactive polymer, a ferromagnetic shape memory alloy, a piezoelectric polymer, a piezoelectric ceramic, or a combination comprising at least one of the foregoing shape memory materials.

5. A morphable molding comprising:
an electrically conductive polymeric matrix; and
a shape memory alloy dispersed in the electrically conductive polymeric matrix; wherein the shape memory alloy upon activation is operative to change the shape, stiffness or dimensions of the morphable molding.

6. The molding of claim 5, wherein the electrically conductive polymeric matrix comprises electrically conductive fillers.

7. The molding of claim 5, wherein the electrically conductive polymeric matrix comprises an elastomer.

8. A morphable molding comprising:
an active material in operative communication with a portion of the molding, wherein activation of the active material by an external stimulus is operative to change the shape, dimensions or stiffness of the molding.

9. The morphable molding of claim 8, wherein the active material is a spring in operative communication with a base and a wall of the morphable molding.

10. The morphable molding of claim 8, wherein the spring comprises a shape memory alloy.

11. The morphable molding of claim 8, wherein the mold comprises thermoplastic or thermosetting polymer.

12. A trim molding for a vehicle, comprising:
a molding fixedly attached to a vehicle door having an end contiguous to the vehicle door hinge, wherein the molding comprises a shape memory actuator positioned in an interior of the molding, wherein the shape memory actuator tapers the molding in response to an activation signal to a degree effective to provide clearance for door opening and closing.

13. An article comprising the morphable molding of claim 1.

14. The article of claim 13, wherein the article comprises an automobile, an automobile bumper, an automobile door, a residential building, an aircraft, a machine tool or furniture.

15. An article comprising the morphable molding of claim 5.

16. An article comprising the morphable molding of claim 8.

17. A method of changing the shape of a molding comprising:
activating an active material that is in operative communication with the molding;
changing the shape, dimensions and/or stiffness of the active material; and
changing the shape, dimensions and/or stiffness of the molding.

18. The method of claim 17, wherein activating of the active material occurs through the application of an external stimulus, wherein the external stimulus is a heat signal, an electrical signal, a magnetic signal, a mechanical signal, a chemical signal, or a combination comprising at least one of the foregoing signals.

19. The method of claim 17, wherein the change in the shape, dimensions and/or stiffness of the active material is proportional to a magnitude of activation.

20. The method of claim 17, wherein the activating of the active material is triggered by the displacement of an article to which the active material is fixedly attached.

21. The method of claim 17, wherein the molding is an automobile bumper.

22. The method of claim 17, wherein the molding is a rub-strip fixedly attached to an automobile door.

23. The method of claim 17, wherein the activating the active material repairs damage to the molding.

24. The method of claim 17, wherein activating the active material facilitates the creation of personalized distinctive bas-relief engravings and/or displays.
